(19) United States
(12) Patent Application Publication
(10) Pub. No.: US 2026/0231079 A1
(43) Pub. Date: Aug. 6, 2026

(54) METHOD AND APPARATUS FOR MANAGING EQUIVALENT STAND-ALONE NON-PUBLIC NETWORK AS HOSTING NETWORK IN A WIRELESS COMMUNICATION SYSTEM

(71) Applicant: Samsung Electronics Co., Ltd., Gyeonggi-do (KR)

(72) Inventors: Lalith KUMAR, Bangalore (IN); Utsav SINHA, Bangalore (IN); Danish Ehsan HASHMI, Bangalore (IN); Varini GUPTA, Bangalore (IN)

(21) Appl. No.: 19/154,975

(22) PCT Filed: Feb. 1, 2024
(86) PCT No.: PCT/KR2024/001522

§ 371 Date: Aug. 8, 2025

(30) Foreign Application Priority Data
Feb. 9, 2023 (IN) 202341008524
Feb. 9, 2023 (IN) 202341008557
Jan. 24, 2024 (IN) 202341008524

(51) Int. Cl. H04W 60/04; H04W 12/08; H04W 48/12

(52) U.S. Cl. CPC H04W 60/04; H04W 12/08; H04W 48/12

(57) ABSTRACT

The disclosure relates to a 5G or 6G communication system for supporting a higher data transmission rate. Specifically, the disclosure related to a method performed by a user equipment (UE) for managing behavior of Equivalent Stand-alone Non-Public Network (SNPN) in a wireless communication system. The method includes sending a registration request message to a network entity, wherein the registration request message includes information of a first SNPN as a hosting network for the UE; receiving, a registration accept message where the registration request message includes information from the network entity, wherein the registration accept message comprises information wherein the at least one second SNPN is an equivalent SNPN for the first SNPN; determining validity conditions for the at least one second SNPN, wherein the validity conditions for the at least one second SNPN is same as validation conditions of the first SNPN; and selecting or reselecting the at least one second SNPN to access localized services based on the validity conditions for the at least one second SNPN.

### TECHNICAL FIELD

The embodiments disclosed herein generally relates to the field of a telecommunication network, and more particularly, to a method and a User Equipment (UE) for understanding behavior of equivalent Stand-alone Non-Public Network (SNPN) for a hosting network (NW) in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The principal disclosure relates to wireless communication systems and, more specifically, the present disclosure relates to methods and apparatus for managing behaviour of Equivalent SNPN as a hosting network in a telecommunication network.

### Solution to Problem

Embodiments disclosed herein provide a method for managing behaviour of Equivalent SNPN as a hosting network in a telecommunication network. The method includes sending, by a UE, a registration request message to a network apparatus. The registration request message includes information of a first SNPN as the hosting network for the UE. Further, the method includes receiving, by the UE, a registration accept message from the network apparatus. The registration accept message includes information of second SNPN as the hosting network for the UE. The second SNPN is an equivalent SNPN for the first SNPN. Further, the method includes determining, by the UE, validity conditions for the second SNPN. The validity conditions for the second SNPN is same as validation conditions of the first SNPN. Further, the method includes selecting or reselecting, by the UE, the second SNPN to access localized services based on the validity conditions for the second SNPN.

In an embodiment, sending, by the UE, the registration request message to the network apparatus includes configuring, by the UE, with the first SNPN in credentials holder prioritized list of preferred SNPN for access for the localized services in the SNPN, enabling, by the UE, to access the localized services, triggering, by the UE, automatic network section of the hosting network, and sending, by the UE, the registration request message to the network apparatus.

In an embodiment, the first SNPN configured in the SNPN is broadcasting a Global Information Network (GIN) configured in the credential's holder prioritized list of preferred SNPN to access for the localized services in the SNPN.

In an embodiment, the validity conditions include validity information about a validity time of the second SNPN registered as the hosting network or a GIN broadcasted by the first SNPN.

In an embodiment, when the UE supports access to the SNPN using credentials from a credential holder, the UE continues selecting and attempting registration on available and allowable SNPNs which broadcasts the indication that access using credentials from the credential holder, and indicates with the validity information with the UE from the SNPN. The UE considers the equivalent SNPN of last registered SNPN, if available and the validity information of the SNPN that the UE was last registered with is met, for automatic SNPN selection, wherein the UE considers that equivalent SNPN provide access to the same localized Services as the SNPN the UE was last registered with.

In an embodiment, the equivalent SNPN provides access to the localized services as the UE was last registered with the SNPN.

In an embodiment, the method includes detecting, by the UE, that the UE supports access to the second SNPN as equivalent SNPN for the first SNPN. Further, the method includes camping, by the UE, the first SNPN to the second SNPN when the UE supports access to the second SNPN as equivalent SNPN for the first SNPN.

Further, the method includes performing, by the UE, a mobility registration update while moving from the first SNPN to the second SNPN.

In an embodiment, the method includes skipping, by the UE, triggering of an initial registration procedure by the UE while moving the first SNPN to the second SNPN. When a new SNPN is selected, the UE initiates a mobility registration update if the UE supports access to an SNPN using credentials from a credentials holder or when the SNPNs are equivalent SNPNs.

In an embodiment, further, the method includes receiving, by the UE, a reject message comparing a re-attempt indicator from the network apparatus for the first SNPN. The re-attempt indicator includes a back-off timer value. Further, the method includes applying, by the UE, the back-off timer value to the second SNPN which is equivalent for the first SNPN. In an SNPN, the network apparatus (200) additionally indicates in the re-attempt indicator that a command to back-off is applicable not only for the SNPN in which the UE (100) received a 5GS session management reject message, but for each SNPN included in the equivalent SNPN list at the time when the 5GS session management reject message is received.

In an embodiment, further, the method includes receiving, by the UE, a reject message including a re-attempt indicator from the network apparatus for the first SNPN. The re-attempt indicator includes a ABO bit (All PLMNs Back-off timer) indicating whether a back-off timer value is applicable in only for the first SNPN where the reject message is received or to the SNPN which is equivalent to the first SNPN. In an embodiment, the method includes applying the back-off timer value to the first SNPN, when the ABO bit indicates that the back-off timer value is applicable in only for the first SNPN. In an embodiment, the method includes applying the back-off timer value to the second SNPN which is equivalent for the first SNPN, when the ABO bit indicates that the back-off timer value is applicable in the second SNPN.

Embodiments disclosed herein provide a UE for managing behaviour of Equivalent SNPN as a hosting network in a telecommunication network. The UE includes an equivalent SNPN controller coupled to a memory and a processor. The UE is configured to send a registration request message to a network apparatus. The registration request message includes information of a first SNPN as the hosting network for the UE. Further, the UE is configured to receive a registration accept message from the network apparatus. The registration accept message includes information of second SNPN. The second SNPN is an equivalent SNPN for the first SNPN. Further, the UE is configured to determine validity conditions for the second SNPN. The validity conditions for the second SNPN is same as validation conditions of the first SNPN. Further, the UE is configured to select or reselect the second SNPN to access localized services based on the validity conditions for the second SNPN which are same as the first SNPN.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### Advantageous Effects of Invention

Aspects of the present disclosure provide efficient communication methods in a wireless communication system.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 illustrates a flow diagram of a UE selects/re-selects to a Stand-alone Non-Public Network (SNPN)-B which might/might not provide local/localized services, according to embodiments as discloses herein;

FIG. 2 illustrates a flow diagram of a proposed method depicting a scenario of the UE selecting/re-selecting to a SNPN-B when needed which can provide local/localized services, according to the embodiments as disclosed herein;

FIG. 3 illustrates a flow diagram of a method depicting the scenario of the UE selects/re-select to the SNPN-B as needed which can provide local/localized services with determined validity conditions, according to the embodiments as disclosed herein;

FIG. 4 illustrates a flow diagram of the proposed method depicting the scenario of an AMF entity sends time and/or location validity conditions of the UE along with the equivalent SNPN list during registration, according to the embodiments as disclosed herein;

FIG. 5 illustrates a flow diagram of the proposed method depicting the scenario of steering of roaming information with SOR-SNPN-SI with updated validity conditions for SNPN-B and Non Access Stratum (NAS) informs of updated validity conditions of SNPN-B to AS, according to the embodiments as disclosed herein;

FIG. 6 illustrates an example scenario in which mobility registration update in SNPN is depicted, according to embodiments as disclosed herein;

FIG. 7 illustrates an example scenario in which mobility registration update in SNPN is depicted, according to embodiments as disclosed herein;

FIG. 8 illustrates an example scenario in which mobility registration update in SNPN is depicted, according to embodiments as disclosed herein;

FIG. 9 illustrates an example scenario in which mobility registration update in SNPN is depicted, according to embodiments as disclosed herein;

FIG. 10 illustrates an example scenario in which mobility registration update in SNPN is depicted, according to embodiments as disclosed herein;

FIG. 11 illustrates various hardware components of the UE, according to the embodiments as disclosed herein;

FIG. 12 is a flow chart illustrating a method for managing behaviour of Equivalent SNPN as a hosting network in a telecommunication network, according to the embodiments as disclosed herein;

FIG. 13 illustrates a block diagram of a terminal (or a user equipment (UE)), according to embodiments of the present disclosure; and

FIG. 14 illustrates a structure of a network entity according to an embodiment of the present disclosure.

It may be noted that to the extent possible, like reference numerals have been used to represent like elements in the drawing. Further, those of ordinary skill in the art will appreciate that elements in the drawing are illustrated for simplicity and may not have been necessarily drawn to scale.

### BEST MODE FOR CARRYING OUT THE INVENTION

Accordingly, the embodiment herein is to provide a method for managing behavior of Equivalent Stand-alone Non-Public Network (SNPN) as a hosting network in a telecommunication network (1000). Further, the method comprises: sending, by a user equipment (UE) (100), a registration request message to a network apparatus (200a), wherein the registration request message comprises information of a first SNPN as the hosting network for the UE (100); receiving, by the UE (100), a registration accept message from the network apparatus (200a), wherein the registration accept message comprises information of at least one second SNPN as the hosting network for the UE (100), and wherein the at least one second SNPN is an equivalent SNPN for the first SNPN; determining, by the UE (100), validity conditions for the at least one second SNPN, wherein the validity conditions for the at least one second SNPN is same as validation conditions of the first SNPN; and selecting or reselecting, by the UE (100), the at least one second SNPN to access localized services based on the validity conditions for the at least one second SNPN.

In an embodiment, by the UEs, wherein sending, by the UE (100), the registration request message to the network apparatus (200a) comprises: configuring, by the UE (100), with the first SNPN in credentials holder prioritized list of preferred SNPN for access for the localized services in the SNPN; enabling, by the UE (100), to access the localized services; triggering, by the UE (100), automatic network section of the hosting network; and sending, by the UE (100), the registration request message to the network apparatus (200a).

In an embodiment, by the UEs, the first SNPN configured in the SNPN is broadcasting a Global Information Network (GIN) configured in the credential's holder prioritized list of preferred SNPN to access for the localized services in the SNPN.

In an embodiment, by the UEs, the validity conditions comprise validity information about a validity time of the at least one second SNPN registered as the hosting network or a GIN broadcasted by the first SNPN.

In an embodiment, by the UEs, when the UE (100) supports access to the SNPN using credentials from a credential holder, the UE (100) continues selecting and attempting registration on available and allowable SNPNs which broadcasts the indication that access using credentials from the credential holder, and indicates with the validity information with the UE (100) from the SNPN, wherein the UE (100) considers the equivalent SNPN of last registered SNPN, if available and the validity information of the SNPN that the UE was last registered with is met, for automatic SNPN selection, wherein the UE (100) considers that equivalent SNPN provide access to the same localized Services as the SNPN the UE was last registered with.

In an embodiment, by the UEs, the equivalent SNPN provides access to the localized services as the UE (100) was last registered with the SNPN.

In an embodiment, by the UEs, the method comprises detecting, by the UE (100), that the UE (100) supports access to the at least one second SNPN as equivalent SNPN for the first SNPN; camping, by the UE (100), the first SNPN to the at least one second SNPN when the UE (100) supports access to the at least one second SNPN as equivalent SNPN for the first SNPN; and performing, by the UE (100), a mobility registration update while moving from the first SNPN to the at least one second SNPN.

In an embodiment, by the UEs, the method comprises skipping, by the UE (100), triggering of an initial registration procedure by the UE (100) while moving the first SNPN to the at least one second SNPN, wherein when a new SNPN is selected, the UE initiates a mobility registration update if the UE supports access to an SNPN using credentials from a credentials holder or when the SNPNs are equivalent SNPNs.

In an embodiment, by the UEs, the method comprises: receiving, by the UE (100), a reject message comparing a re-attempt indicator from the network apparatus (200a) for the first SNPN, wherein the re-attempt indicator comprises a back-off timer value, and applying, by the UE (100), the back-off timer value to the at least one second SNPN which is equivalent for the first SNPN, wherein in an SNPN, the network apparatus (200a) additionally indicates in the re-attempt indicator that a command to back-off is applicable not only for the SNPN in which the UE (100) received a 5GS session management reject message, but for each SNPN included in the equivalent SNPN list at the time when the 5GS session management reject message is received.

In an embodiment, by the UEs, the method comprises: receiving, by the UE (100), a reject message comprising a re-attempt indicator from the network apparatus (200a) for the first SNPN, wherein the re-attempt indicator comprises an ABO bit (All PLMNs Back-off timer) indicating whether a back-off timer value is applicable in only for the first SNPN where the reject message is received or to the at least one SNPN which is equivalent to the first SNPN; and performing, by the UE (100), one of: applying the back-off timer value to the first SNPN, when the ABO bit indicates that the back-off timer value is applicable in only for the first SNPN, and applying the back-off timer value to the at least one second SNPN which is equivalent for the first SNPN, when the ABO bit indicates that the back-off timer value is applicable in the at least one second SNPN.

Accordingly, the embodiment herein is to provide a user equipment (UE) for managing behaviour of Equivalent Stand-alone Non-Public Network (SNPN) as a hosting network in a telecommunication network (1000), comprising: a memory (130), a processor (110) and an equivalent SNPN controller (140), coupled to the memory (130) and the processor (110). The equivalent SNPN controller configured to: send a registration request message to a network apparatus (200a), wherein the registration request message comprises information of a first SNPN as the hosting network for the UE (100); receive a registration accept message from the network apparatus (200a), wherein the registration accept message comprises information of at least one second SNPN as the hosting network for the UE (100), and wherein the at least one second SNPN is an equivalent SNPN for the first SNPN; determine validity conditions for the at least one second SNPN, wherein the validity conditions for the at least one second SNPN is same as validation conditions of the first SNPN; and select or reselect the at least one second SNPN to access localized services based on the validity conditions for the at least one second SNPN.

In an embodiment, by the UEs, the equivalent SNPN controller further configured to: configure with the first SNPN in credentials holder prioritized list of preferred SNPN for access for the localized services in the SNPN; enable to access the localized services; trigger automatic network section of the hosting network; and send the registration request message to the network apparatus (200a).

In an embodiment, by the UEs, the first SNPN configured in the SNPN is broadcasting a Global Information Network (GIN) configured in the credential's holder prioritized list of preferred SNPN to access for the localized services in the SNPN.

In an embodiment, by the UEs, the validity conditions comprise validity information about a validity time of the at least one second SNPN registered as the hosting network or a GIN broadcasted by the first SNPN.

In an embodiment, by the UEs, when the UE (100) supports access to the SNPN using credentials from a credential holder, the UE (100) continues selecting and attempting registration on available and allowable SNPNs which broadcasts the indication that access using credentials from the credential holder, and indicates with the validity information with the UE (100) from the SNPN, wherein the UE (100) considers the equivalent SNPN of last registered SNPN, if available and the validity information of the SNPN that the UE was last registered with is met, for automatic SNPN selection, wherein the UE (100) considers that equivalent SNPN provide access to the same localized Services as the SNPN the UE (100) was last registered with.

In an embodiment, by the UEs, the equivalent SNPN provides access to the localized services as the UE (100) was last registered with the SNPN.

In an embodiment, by the UEs, the equivalent SNPN controller further configured to detect that the UE (100) supports access to the at least one second SNPN as equivalent SNPN for the first SNPN; camp the first SNPN to the at least one second SNPN when the UE (100) supports access to the at least one second SNPN as equivalent SNPN for the first SNPN; and perform a mobility registration update while moving from the first SNPN to the at least one second SNPN.

In an embodiment, by the UEs, the equivalent SNPN controller (140) is configured to skip triggering of an initial registration procedure by the UE (100) while moving the first SNPN to the at least one second SNPN, wherein when a new SNPN is selected, the UE (100) initiates a mobility registration update if the UE (100) supports access to an SNPN using credentials from a credentials holder or when the SNPNs are equivalent SNPNs.

In an embodiment, by the UEs, the equivalent SNPN controller further configured to receive a reject message comparing a re-attempt indicator from the network apparatus (200a) for the first SNPN, wherein the re-attempt indicator comprises a back-off timer value, and apply the back-off timer value to the at least one second SNPN which is equivalent for the first SNPN, wherein in an SNPN, the network apparatus (200a) additionally indicates in the re-attempt indicator that a command to back-off is applicable not only for the SNPN in which the UE (100) received a 5GS session management reject message, but for each SNPN included in the equivalent SNPN list at the time when the 5GS session management reject message is received.

In an embodiment, by the UEs, the equivalent SNPN controller further configured to receive a reject message comprising a re-attempt indicator from the network apparatus (200a) for the first SNPN, wherein the re-attempt indicator comprises an ABO bit (All PLMNs Back-off timer) indicating whether a back-off timer value is applicable in only for the first SNPN where the reject message is received or to the at least one SNPN which is equivalent to the first SNPN; perform one of: apply the back-off timer value to the first SNPN, when the ABO bit indicates that the back-off timer value is applicable in only for the first SNPN, and apply the back-off timer value to the at least one second SNPN which is equivalent for the first SNPN, when the ABO bit indicates that the back-off timer value is applicable in the at least one second SNPN.

### Mode for the Invention

In one embodiment, object of the embodiments herein is to provide that the UE performs mobility registration update, when the UE supports access to an SNPN using credentials from a CH, or supports equivalent SNPNs, and the UE moves between such SNPNs.

Another object of the embodiments herein is to provide that the UE triggers an initial registration procedure when moving between such SNPNs.

Another object of the embodiments herein is to provide that, in an SNPN, the re-attempt indicator will be applicable as well. If the network apparatus rejects the UE with a 5GSM cause not related to congestion, the network apparatus may additionally indicate in an re-attempt indicator that a command to back-off is applicable not only for the SNPN in which the UE received the 5GS session management reject message, but for each SNPN included in the equivalent SNPN list at the time when the 5GS session management reject message is received.

Another object of the embodiments herein is to provide that, in the SNPN, for slice based congestion control, when the network apparatus rejects the UE with cause #67 or #69, and includes the 5GSM congestion re-attempt indicator IE, then ABO bit in the IE will indicate whether timer T3584/T3585 is applicable to only the registered SNPN/all other SNPNs as well.

Another object of the embodiments herein is to provide that an equivalent SNPN(s) provides the same set of localized services as the registered SNPN, and have the same location and time validity criterion when the UE considers that equivalent SNPN(s), even if not configured in “credentials holder controlled prioritized list of preferred SNPNs for access for localized services in SNPN” or not broadcasting a GIN configured in “credentials holder controlled prioritized list of preferred GINs for access for localized services in SNPN”.

Another object of the embodiments herein is to re-attempt indicator for 5GSM reject causes in equivalent SNPNs.

Another object of the embodiments herein is to use ABO bit for slice level congestion in SNPNs.

In general, 3rd Generation Partnership Project (3GPP) has introduced the concept of localized services. The localized service is a service which is localized (i.e. provided at specific/limited area) and/or can be bounded in time. The service can be realized via applications (e.g. live or on-demand audio/video stream, electric game, IP Multimedia Subsystem (IMS), etc.), or connectivity (e.g. User Equipment (UE) to UE, UE to Data Network, etc.). A service provider provides such service is called a localized service provider. The localized service provider is an application provider or a network operator who make their services localized and to be offered to end user via a hosting network.

A network providing access to such local/localized service is known as a hosting network. Hosting network information is shared with the UE by mechanisms defined in the 3GPP standards. The hosting network information comes with time validity and geo location information, which defines the area and the time/duration of the day when the localized services will be available. As per current standards, the hosting network can be either be
a) SNPN, OR
b) Public network integrated-non Public network (PNI-NPN)

The information for the hosting network, selection and access can be preconfigured in the UE or dynamically provisioned by a home network (via Visiting Public Land Mobile Network (VPLMN) when roaming) using existing mechanisms. In the case of the SNPN as hosting network, the dynamic provisioning of prioritized list of hosting network information can be done via Steering of Roaming (SoR) mechanism. In the case of PNI-NPN as the hosting network, the dynamic provisioning of allowed CAG ID list is used to update the hosting network information.

Credentials Holder (CH) controlled prioritized list of SNPNs/GINs: A credentials holder (CH) is an entity which authenticates and authorizes access to the SNPN separate from the CH. The CH can be a hosting network as part of this list. If the UE supports access to the SNPN using credentials from the credentials holder, the UE can be configured with the credentials holder controlled prioritized list of preferred SNPNs or Global Information Network (GIN). This list is used by the UE to perform SNPN selection, associated to one entry in the “list of subscriber data”, and also for mobility. The name of this list is only for illustration purpose it can be any name, in summary this list consists of at least hosting networks in the prioritized order.

For the case of the SNPN as the hosting network, for automatic SNPN selection, the existing credentials holder controlled prioritized list of preferred SNPNs (and GINs) is extended for each entry in the list, time and location validity information. The entry may include time validity only, location validity only, or both. The information for the hosting network, selection and access can be preconfigured in the UE or dynamically provisioned by the home network (via the VPLMN when roaming) using existing mechanisms. In the case of the SNPN as the hosting network, the dynamic provisioning of prioritized list of hosting network information can be done via the SoR mechanism. If the UE is configured with the credential holder controlled prioritized lists of preferred SNPNs and GINs and the lists contain entries with the validity condition and the validity condition is met for at least one of those entries, then the UE may select the related SNPNs even if the subscribed SNPN (if any) is available (i.e. the hosting network may have a higher priority than the subscribed SNPN).

However, the conventional methods fail to how the SoR mechanism holds true for an equivalent SNPN of the hosting network. At present, standard says, the UE is to consider the SNPNs configured as part of the credential's holder controlled prioritized list of preferred SNPNs (and GINs) with time/location validity information as the hosting network. Although, when the UE finds and registers in the hosting SNPN (for example), that SNPN can indicate another SNPN as its equivalent SNPN. It is also possible that the equivalent SNPN is not configured by the home network as an available hosting network with time/location validity information in the credential's holder controlled prioritized list of preferred SNPNs (and GINs). Based on rules of automatic selection, the UE is always allowed to select the selected SNPN or its equivalent SNPN for registration. It needs to be similarly clarified for the case of the hosting SNPN, whether the UE can consider the equivalent SNPN of hosting SNPN as a suitable hosting network or not, for local/localized services, even if it is not configured in the credential's holder controlled prioritized list of preferred SNPNs (and GINs) with time/location validity information.

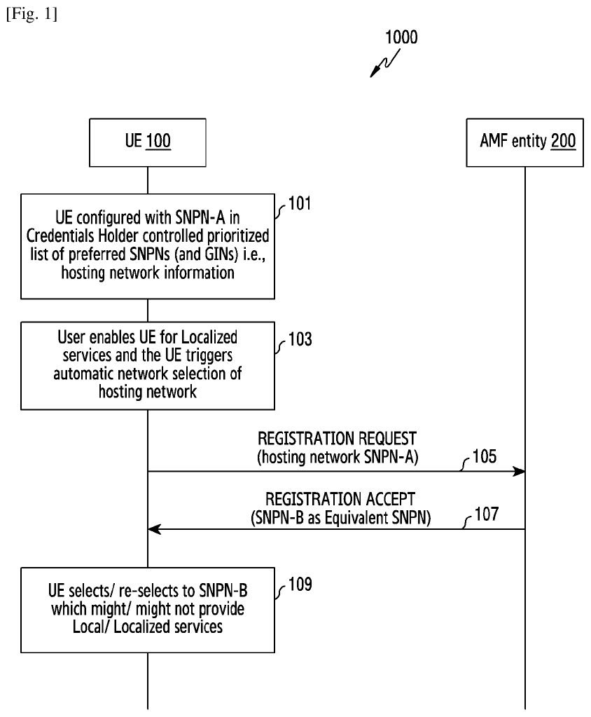

FIG. 1 illustrates a flow diagram of the UE (100) selects/re-selects to a SNPN-B which might/might not provide the local/localized services, according to embodiments as discloses herein.

At step 101, the UE (100) is configured with the SNPN-A in the credentials Holder controlled prioritized list of preferred SNPNs (and GINs) (i.e. hosting network information) in a telecommunication network (1000). At step 103, the user of the UE (100) enables the UE (100) for the localized services and the UE (100) triggers an automatic network selection of the hosting network. At step 105, the UE (100) sends a registration request including the hosting network SNPN-A to an Access & Mobility Management Function (AMF) entity (200). At step 107, the UE (100) receives the registration accept including the SNPN-B as Equivalent SNPN from the AMF entity (200) based on the registration request. At step 109, the UE (100) selects/re-selects to the SNPN-B which might/might not provide local/localized services.

Further, consider, the SNPN is a non-public 5G network and when the UE (100) is the SNPN enabled, the UE (100) can operate in a SNPN access operation mode. In the SNPN access operation mode, the UE (100) can select and register in the SNPNs.

Instead of Public Land Mobile Network (PLMN), the SNPN selection is performed by the UE (100) as per TS 3GPP 23.122. In Rel 16 art, the roaming between SNPNs was not supported. With Rel17 and later, the concept of CH (Credentials Holder) for SNPN and equivalent SNPNs were introduced. It is possible for the UE (100) to access the SNPN with credentials from the CH as described in clause 5.30.2.9 and to move between equivalent SNPNs.

SM retry with congestion/no congestion: The network may detect and start performing S-NSSAI (Single-Network Slice Selection Assistance Information) based congestion control when one or more S-NSSAI congestion criteria as specified in 3GPP TS 23.501 are met. The reject can be for the specific slice or slice & Data Network Name (DNN) combination. For cases not due to congestion control, the network may include a back-off timer value in a 5GS session management reject message to regulate the time interval at which the UE (100) may retry the same procedure for 5GSM cause values other than ones mentioned in 3GPP TS 24.501, which are not due to congestion. Both of these are applicable for PLMNs as per current art.

As per 3GPP TS 24.501, if a new SNPN is selected, the UE (100) shall reset a registration attempt counter, may perform de-registration locally and shall initiate a registration procedure for initial registration. The above should not hold true anymore with the introduction of credentials holder (CH) and concept of equivalent SNPNs. This is because:
a) With the introduction of the CH, an SNPN enabled UE (100) can use the same credentials provided by the CH, and register in another SNPN which is associated with the selected entry of the “list of subscriber data” associated with the registered SNPN, as configured in a mobile Equipment (ME), if the UE (100) is not registering or registered for onboarding services in the SNPN.
b) The SNPNs in the list of equivalent SNPNs associated with the selected entry of “list of subscriber data” or the selected PLMN subscription shall be regarded by the UE (100) as equivalent to each other for SNPN selection, cell selection and cell re-selection. So, when a UE (100) is moving in between equivalent SNPNs, it cannot be referred to as “initial registration” any further. As per 3GPP TS 24.501,
1. The network may include a back-off timer value in a 5GS session management reject message to regulate the time interval at which the UE (100) may retry the same procedure for 5GSM cause values other than ones mentioned in 3GPP TS 24.501. The network may additionally indicate in the re-attempt indicator information element (IE) that a command to back-off is applicable not only for the PLMN in which the UE (100) received the 5GS session management reject message, but for each PLMN included in the equivalent PLMN list. The Re-attempt indicator IE is not applicable to SNPNs now.
2. The network may detect and start performing S-NSSAI based congestion control when one or more S-NSSAI congestion criteria as specified in 3GPP TS 23.501 [8 ] are met. The network can reject a UE (100) request due to slice congestion with causes #67 “insufficient resources for specific slice and DNN” or #69 “insufficient resources for specific slice“, in the 5GSM congestion re-attempt indicator IE in the reject message. If the “ABO bit” is set in the above IE, it means the back-off congestion is not just in current PLMN, but in all PLMNs. This is not applicable to SNPNs now.

The above information is presented as background information only to help the reader to understand the present invention. Applicants have made no determination and make no assertion as to whether any of the above might be applicable as prior art with regard to the present application.

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Embodiments disclosed herein provide a method for managing behaviour of Equivalent SNPN as a hosting network in a telecommunication network. The method includes sending, by a UE, a registration request message to a network apparatus. The registration request message includes information of a first SNPN as the hosting network for the UE. Further, the method includes receiving, by the UE, a registration accept message from the network apparatus. The registration accept message includes information of second SNPN as the hosting network for the UE. The second SNPN is an equivalent SNPN for the first SNPN. Further, the method includes determining, by the UE, validity conditions for the second SNPN. The validity conditions for the second SNPN is same as validation conditions of the first SNPN. Further, the method includes selecting or reselecting, by the UE, the second SNPN to access the same kind of localized services based on the validity conditions for the second SNPN which are same as first SNPN.

In an embodiment, the UE consider SNPNs configured as part of CH controlled prioritized list of preferred SNPNs (and GINs) with time/location validity information as hosting network. When the UE finds and registers in a hosting SNPN for example, that SNPN can indicate another SNPN as its equivalent SNPN. The equivalent SNPN is not configured by a home network as available hosting network with time/location validity information in a CH controlled prioritized list of preferred SNPNs. Based on rules of automatic selection, the UE is always allowed to select SNPN or its equivalent SNPN for registration. Clarifying, whether the UE can consider equivalent SNPN of hosting SNPN as suitable hosting network or not, for Local/Localized services, even if it is not configured in Credentials Holder controlled prioritized list of preferred SNPNs (and GINs) with time/location validity information.

In an embodiment, when the UE supports access to an SNPN using credentials from a CH, or supports equivalent SNPNs, and the UE moves between such SNPNs, the UE shall perform mobility registration update. Otherwise, the UE will trigger initial registration procedure when moving between such SNPNs. For example: Say UE supports access to an SNPN using credentials from a CH, and the UE is configured with a CH controlled list of preferred SNPNs or GINs, the subscribed SNPN is SNPN-1, and SNPN-2 is configured in selected entry of list of subscriber data. As long as the UE is using the same selected entry of the list of subscriber data, and the UE moves in between SNPN-1 and SNPN-2, the UE shall use mobility registration update instead of initial update.

Similarly, as when the UE registers in SNPN-1 using the selected entry of the list of subscriber data, and the network indicates SNPN-3 as E-SNPN of SNPN-1. When UE moves in between SNPN-1 and SNPN-3, the UE shall use mobility registration update instead of initial update.

In an embodiment, in the SNPN, the re-attempt indicator will be applicable as well. If the network rejects the UE with 5GSM cause not related to congestion, the network may additionally indicate in the re-attempt indicator that a command to back-off is applicable not only for the SNPN in which the UE received the 5GS session management reject message, but for each SNPN included in the equivalent SNPN list at the time when the 5GS session management reject message was received. For example. Say the UE gets rejected with cause #27 for a PDU session establishment request, includes the back-off timer value, and the re-attempt indicator indicates value “0”. And say the UE is registered in SNPN-1 and SNPN-2 is its' equivalent SNPN, then this means that the back-off timer is applicable not only to SNPN-1, but also to SNPN-2.

In an embodiment, in the SNPN, for slice based congestion control, if the network rejects the UE is cause #67/#69, and includes the 5GSM congestion re-attempt indicator IE, then ABO bit in this IE will indicate whether timer T3584/T3585 is applicable to only the registered SNPN/all other SNPNs as well. For example, say UE is registered in SNPN-1, and SNPN-2 is its equivalent SNPN. UE performs 5GSM procedure, gets rejected for S-NSSAI-1, with cause #67. And the ABO bit in the 5GSM congestion re-attempt indicator indicates “1”. This means that the timer T3584 is applicable for the S-NSSAI-1, DNN and SNPN-1 combination, and also for S-NSSAI, DNN and SNPN-2 combination.

In an embodiment, The MS is operating in SNPN access mode & supports access to an SNPN providing access for localized services in SNPN.

The access for localized services in SNPN is enabled (i.e. the MS can select an SNPN only if it is configured in the “credentials holder controlled prioritized list of preferred SNPNs for access for localized services in SNPN” or the SNPN is broadcasting a GIN configured in the “credentials holder controlled prioritized list of preferred GINs for access for localized services in SNPN”). The time validity of the registered SNPN or the GIN broadcasted by the SNPN is met.

In an embodiment, the UE shall consider the equivalent SNPN of last registered SNPN (if available and the validity information of the SNPN that the UE was last registered with is met) for automatic SNPN selection. The UE shall consider that equivalent SNPN(s) provide access to the same Localized Services as the SNPN the UE was last registered with.

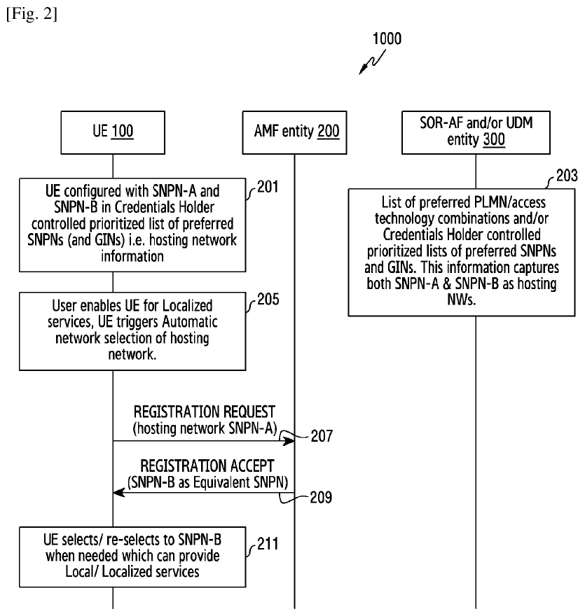

Referring now to the drawings, and more particularly to FIGS. 2 through 12, where similar reference characters denote corresponding features consistently throughout the figures, there are shown at least one embodiment.

FIG. 2 illustrates a flow diagram of the proposed method depicting the scenario of UE (100) selects/re-selects to the SNPN-B when needed which can provide local/ localized services, according to the embodiments as disclosed herein. The SNPN-B is equivalent SNPN of SNPN-B. Both SNPN-A and SNPN-B are configured as the hosting networks for the UE (100). The UE (100) can select/re-select to SNPN-B as and when required for the localized services.

At step 201, the UE (100) is configured with the SNPN-A in the credentials Holder controlled prioritized list of preferred SNPNs (and GINs) (i.e. hosting network information) in a telecommunication network (1000). At step 203, SOR-AF and/or UDM entity (300) stores the list of preferred PLMN/access technology combinations and/or credentials holder controlled prioritized lists of preferred SNPNs and GINs. This information captures both SNPN-A & SNPN-B as hosting NWs. At step 205, the user of the UE (100) enables the UE (100) for the localized services and the UE (100) triggers an automatic network selection of the hosting network.

At step 207, the UE (100) sends a registration request including the hosting network SNPN-A to an Access & Mobility Management Function (AMF) entity (200). At step 209, the UE (100) receives the registration accept including the SNPN-B as Equivalent SNPN from the AMF entity (200) based on the registration request. At step 211, the UE (100) selects/re-selects to the SNPN-B which might/might not provide local/localized services.

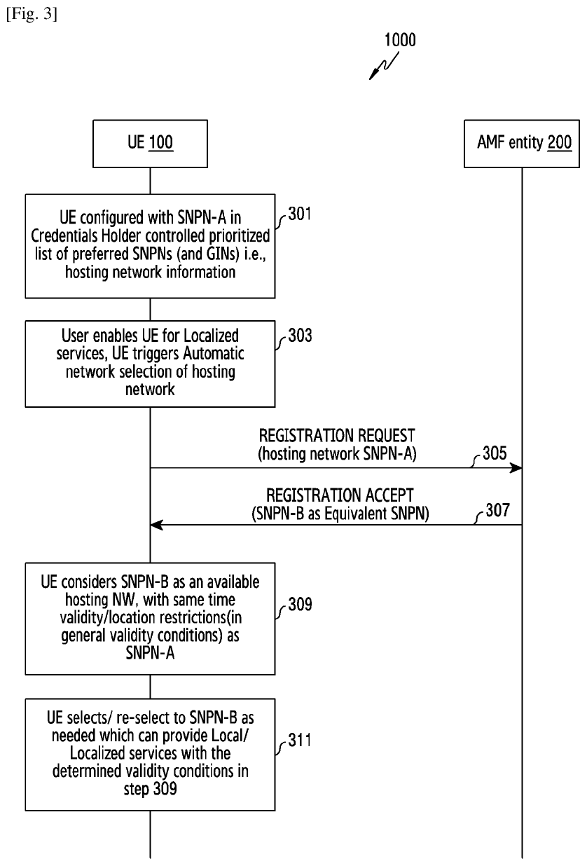

FIG. 3 illustrates a flow diagram of method depicts the scenario of the UE (100) selects/re-select to SNPN-B as needed which can provide Local/Localized services with the determined validity conditions, according to the embodiments as disclosed herein. The SNPN-B is an equivalent SNPN of SNPN-A. But SNPN-B is not configured as a hosting network for the UE (100). The UE (100) implicitly assumes that SNPN-B is also an available hosting network with the same time and/OR location validity conditions as SNPN-A.

The UE (100) should implicitly assume, that equivalent SNPNs of hosting SNPNs included in Credentials Holder controlled prioritized list of preferred SNPNs (and GINs) can be considered for hosting network selection as well for the same Local/ Localized services. It needs to be assumed that the time and/OR location validity (in general validity conditions) of the equivalent SNPNs is same as the registered SNPN. For example if UE (100) is registered in hosting network SNPN-A, which has allowed localized service to a UE (100) from 10 am to 2 pm in the day. SNPN-A has SNPN-B as equivalent SNPN, which is not included in the Credentials Holder controlled prioritized list with time validity information. The UE (100) should assume that SNPN-B can also provide Localized service from 10 am to 2 pm in the day i.e. same validation conditions.

At step 301, the UE (100) is configured with the SNPN-A in the credentials holder controlled prioritized list of preferred SNPNs (and GINs) i.e., hosting network information. At step 303, the user enables the UE (100) for localized services and the UE (100) triggers the automatic network selection of the hosting network. At step 305, the UE (100) sends the registration request including the hosting network SNPN-A to the AMF entity (200). At step 307, the UE (100) receives the registration accept including the SNPN-B as the Equivalent SNPN from the AMF entity (200). At step 309, the UE (100) considers the SNPN-B as an available hosting network with same time validity/location restrictions (in general validity conditions) as SNPN-A. At step 311, the UE (100) selects/re-select to the SNPN-B as needed which can provide local/localized services with the determined validity conditions in step 309.

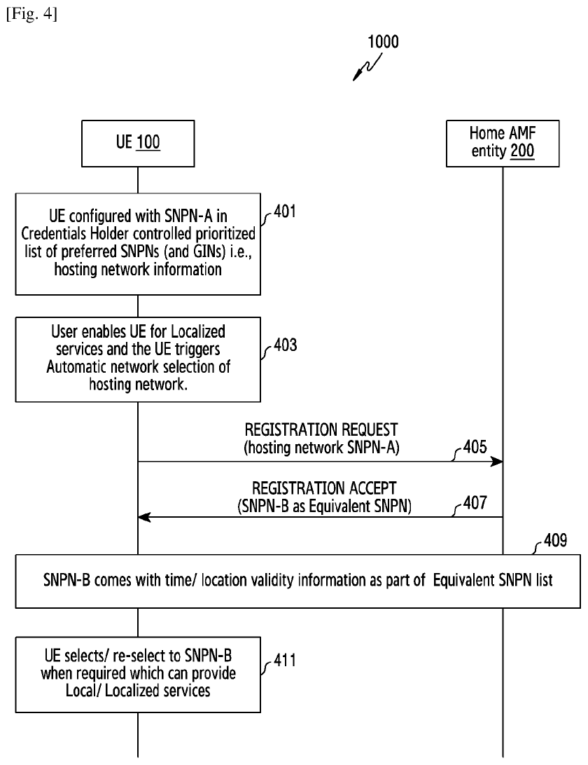

FIG. 4 illustrates a flow diagram of the proposed method depicts the scenario of AMF entity (200) sends time and/or location validity conditions of the UE (100) along with the equivalent SNPN list during registration, according to the embodiments as disclosed herein. The SNPN-B is equivalent SNPN of SNPN-A, but SNPN-B is not configured as a hosting network for the UE (100). But the AMF entity (200) sends the time and/OR location validity conditions of the UE (100) along with the equivalent SNPN list, during registration for example. With this, the UE (100) considers SNPN-B as well as a hosting network.

At step 401, the UE (100) is configured with the SNPN-A in the credentials holder controlled prioritized list of preferred SNPNs (and GINs) i.e., hosting network information. At step 403, the user enables the UE (100) for localized services and the UE (100) triggers the automatic network selection of the hosting network. At step 405, the UE (100) sends the registration request including the hosting network SNPN-A to the AMF entity (200). At step 407, the UE (100) receives the registration accept including the SNPN-B as the Equivalent SNPN from the AMF entity (200). At step 409, the AMF entity (200) sends the time and/OR location validity conditions of the UE (100) along with the equivalent SNPN list, during registration. At step 411, the UE (100) considers SNPN-B as well as a hosting network, and the UE (100) selects/re-select to the SNPN-B as needed which can provide local/localized services.

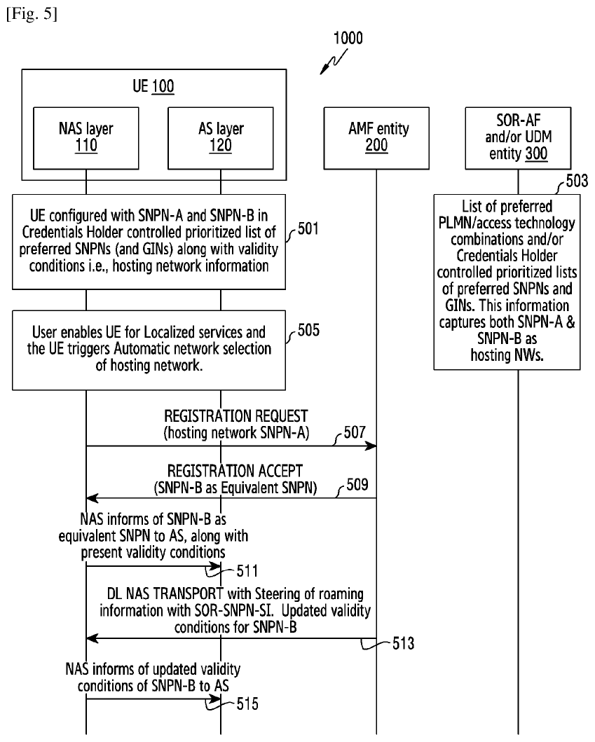

FIG. 5 illustrates a flow diagram of the proposed method depicts the scenario of Steering of roaming information with SOR-SNPN-SI with updated validity conditions for SNPN-B and NAS informs of updated validity conditions of SNPN-B to AS, according to the embodiments as disclosed herein. The SNPN-B is configured/UE (100) considers SNPN-B to be a hosting network with specific validity conditions. And SNPN-B is also an equivalent SNPN of SNPN-A. NAS informs of SNPN-B as equivalent SNPN to AS, along with present validity conditions. Steering of roaming information with SOR-SNPN-SI with updated validity conditions for SNPN-B. NAS informs of updated validity conditions of SNPN-B to AS.

The NAS (Non Access Stratum) will share the equivalent SNPN information with AS (Access Stratum) based on validity conditions with the relevant time and/OR Location validity information.

For an SNPN enabled UE (100), which is operating in SNPN access operation mode, when it selects a new SNPN:

If the selected SNPN is an equivalent SNPN or if the SNPN belongs to the Credentials Holder controlled prioritized list of preferred SNPNs or GINs, associated with the selected entry of the “list of subscriber data” or the PLMN subscription, or belongs to below optionally of selected entry of the “list of subscriber data” or the PLMN subscription:
a) a user controlled prioritized list of preferred SNPNs, where each entry contains an SNPN identity;
b) a credentials holder controlled prioritized list of preferred SNPNs, where each entry contains an SNPN identity; and
c) a credentials holder controlled prioritized list of Group IDs for Network Selection (GINs);

The UE (100) shall trigger Registration procedure for mobility and periodic registration update; for e.g., by setting 5GS registration type as “mobility registration updating”. For example, the UE (100) is registered in SNPN-A. SNPN-B is an equivalent SNPN of SNPN-A, or SNPN-B is part of the credentials holder controlled prioritized list of preferred SNPNs or GINs for the associated entry of the “list of subscriber data” of SNPN-A, if the UE (100) moves from SNPN-A to SNPN-B, it shall initiate a registration procedure for mobility registration update.
1. b) The UE (100) shall initiate a registration procedure for initial registration (see subclause 5.5.1.2.2) if the selected SNPN is not an equivalent SNPN or the SNPN does not belong to the Credentials Holder controlled prioritized list of preferred SNPNs or GINs, associated with the selected entry of the “list of subscriber data” or the PLMN subscription. Or does not belong to below list:
1) a user controlled prioritized list of preferred SNPNs, where each entry contains an SNPN identity;
2) a credentials holder controlled prioritized list of preferred SNPNs, where each entry contains an SNPN identity; and
3) a credentials holder controlled prioritized list of Group IDs for Network Selection (GINs);

For example, the UE (100) is registered in SNPN-A. SNPN-B is neither an equivalent SNPN of SNPN-A, nor SNPN-B is part of the Credentials Holder controlled prioritized list of preferred SNPNs or GINs for the associated entry of the “list of subscriber data” of SNPN-A, if UE (100) moves from SNPN-A to SNPN-B, it shall initiate a registration procedure for initial registration.

At step 501, the UE (100) is configured with the SNPN-A and the SNPN-B in the credential's holder controlled prioritized list of preferred SNPNs (and GINs) along with validity conditions (i.e., hosting network information). At step 503, SOR-AF and/ or UDM entity (300) stores the list of preferred PLMN/access technology combinations and/or credentials holder controlled prioritized lists of preferred SNPNs and GINs. This information captures both SNPN-A & SNPN-B as hosting NWs. At step 505, the user enables the UE (100) for the localized services and the UE (100) triggers the automatic network selection of the hosting network. At step 507, the UE (100) sends the registration request including the hosting network SNPN-A to the AMF entity (200). At step 509, the UE (100) receives the registration accept including the SNPN-B as Equivalent SNPN from the AMF entity (200). At step 511, the NAS layer of the UE (100) informs of the SNPN-B as equivalent SNPN to the AS layer, along with present validity conditions. At step 513, the AMF entity (200) sends the DL NAS TRANSPORT with Steering of roaming information with SOR-SNPN-SI to the UE (100). The AMF entity (200) sends the updated validity conditions for SNPN-B to the UE (100). At step 515, the NAS layer informs of updated validity conditions of SNPN-B to the AS layer of the UE (100).

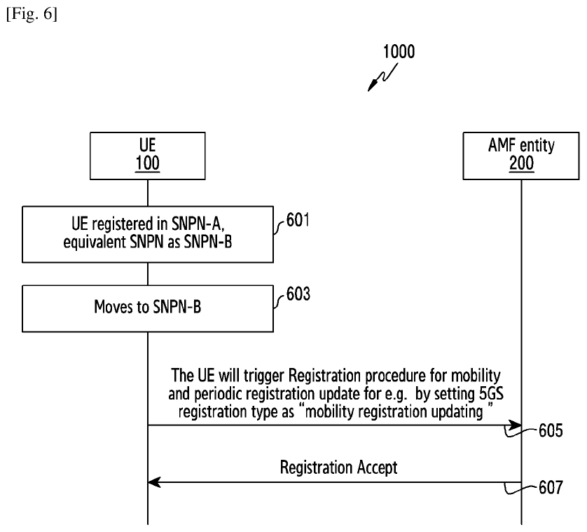

FIG. 6-FIG. 10 various example scenarios in which mobility registration update in SNPN is depicted, according to embodiments as disclosed herein.

FIG. 6 illustrates an example scenario in which mobility registration update in SNPN is depicted, according to embodiments as disclosed herein.

As illustrated in FIG. 6, at step 601, the UE (100) is registered in SNPN-A, equivalent SNPN as SNPN-B. At step 603, the UE (100) moves to SNPN-B. At step 605, the UE (100) will trigger Registration procedure for mobility and periodic registration update (for e.g.,) by setting a 5GS registration type as “mobility registration updating” to the AMF entity (200). At step 607, the UE (100) receives the registration accept from the AMF entity (200).

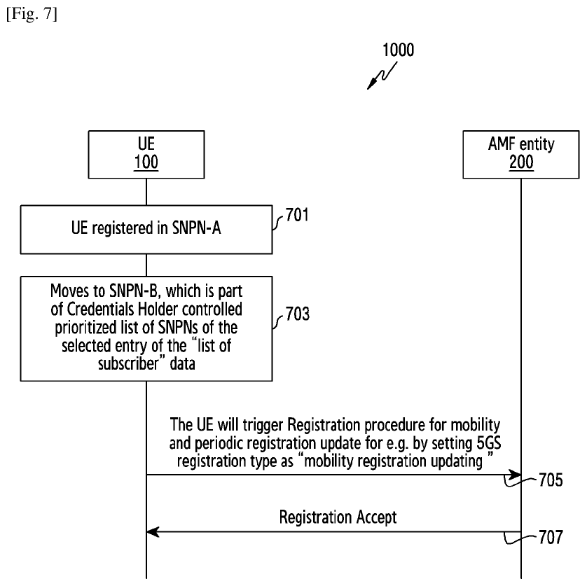

FIG. 7 illustrates an example scenario in which mobility registration update in SNPN is depicted, according to embodiments as disclosed herein.

As illustrated in FIG. 7, at step 701, the UE (100) is registered in SNPN-A. At step 703, the UE (100) moves to SNPN-B, which is part of Credentials Holder controlled prioritized list of SNPNs of the selected entry of the “list of subscriber” data. At step 705, the UE (100) will trigger the Registration procedure for mobility and periodic registration update; for e.g., by setting 5GS registration type as “mobility registration updating” to the AMF entity (200). At step 707, the UE (100) receives the registration accept from the AMF entity (200).

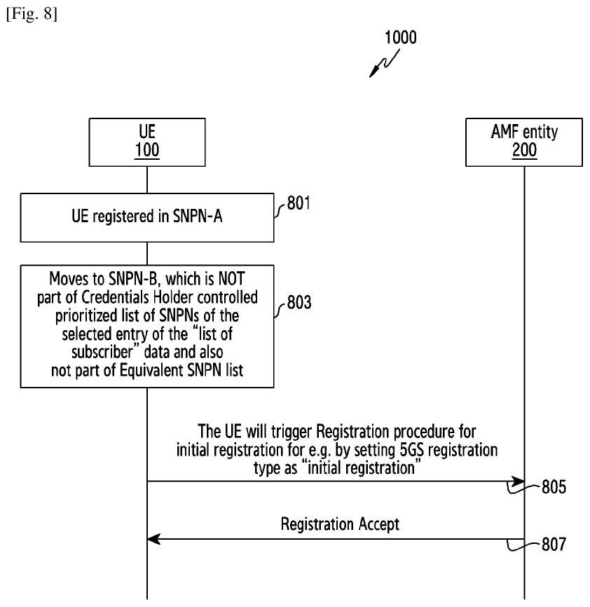

FIG. 8 illustrates an example scenario in which mobility registration update in SNPN is depicted, according to embodiments as disclosed herein.

As shown in FIG. 8, at step 801, the UE (100) is registered in SNPN-A. At step 803, the UE (100) moves to SNPN-B, which is NOT part of the Credentials Holder controlled prioritized list of SNPNs of the selected entry of the “list of subscriber” data and also not part of Equivalent SNPN list. At step 805, the UE (100) will trigger Registration procedure for initial registration; for e.g., by setting 5GS registration type as “initial registration” to the AMF entity (200). At step 807, the UE (100) receives the registration accept from the AMF entity (200).

The Re-attempt indicator IE can be applicable to SNPNs as well. The “EPLMNC” bit in this IE can indicate whether the rejected session management procedure can be retried for the same SNPN or equivalent SNPNs for the same DNN.

In a PLMN or SNPN, the network may additionally indicate in the re-attempt indicator that a command to back-off is applicable not only for the PLMN or SNPN in which the UE (100) received the 5GS session management reject message, but for each PLMN included in the equivalent PLMN list or for each SNPN included in the equivalent SNPN list at the time when the 5GS session management reject message was received.

5GSM congestion re-attempt indicator IE can be applicable for SNPNs as well. The “ABO bit” in this IE can indicate whether the congestion back-off is applicable in only the SNPN where the reject message was received or whether in all SNPNs.
1. In case of PLMN or SNPN, in the UE (100), 5GS session management timers T3584 for the S-NSSAI based congestion control are started and stopped on a per S-NSSAI, DNN and PLMN or SNPN basis. If the 5GSM congestion re-attempt indicator IE with the ABO bit set to “The back-off timer is applied in all PLMNs or all SNPNs” is included in the 5GSM message with the 5GSM cause value #67 “insufficient resources for specific slice and DNN”, then the UE (100) applies the timer T3584 for all the PLMNs or all the SNPNs. Otherwise, the UE (100) applies the timer T3584 for the registered PLMN or the registered SNPN.
2. In case of PLMN or SNPN, in the UE (100), 5GS session management timers T3585 for the S-NSSAI based congestion control are started and stopped on a per S-NSSAI and PLMN or SNPN basis. If the 5GSM congestion re-attempt indicator IE with the ABO bit set to “The back-off timer is applied in all PLMNs or all SNPNs” is included in the 5GSM message with the 5GSM cause value #69 “insufficient resources for specific slice”, then the UE (100) applies the timer T3585 for all the PLMNs or SNPNs. Otherwise, the UE (100) applies the timer T3585 for the registered PLMN or registered SNPN.

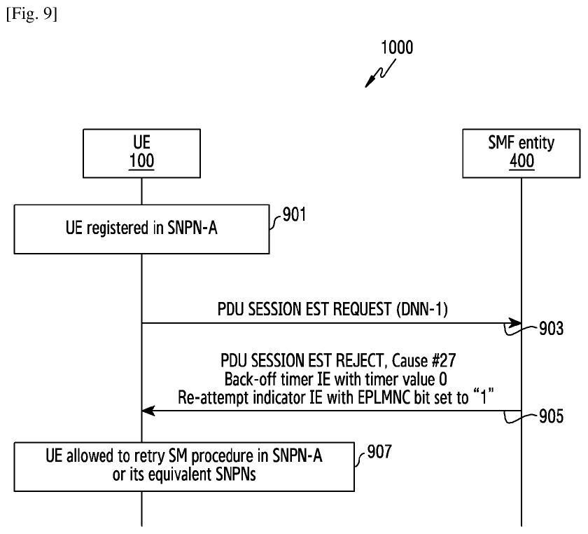

FIG. 9 illustrates an example scenario in which mobility registration update in SNPN is depicted, according to embodiments as disclosed herein.

As illustrated in FIG. 9, at step 901, the UE (100) is registered in SNPN-A. At step 903, the UE (100) triggers PDU session establishment request for DNN-1. At step 905, the UE (100) gets rejected with cause #27, and non-zero back-off timer value from a Session Management Function (SMF) entity (400). The EPLMN bit in the Re-attempt indicator is set to value 1. The back-off timer will be applicable not only to the registered SNPN, but to each of its equivalent SNPNs. At step 907, the UE (100) allowed to retry SM procedure in SNPN-A or its equivalent SNPNs.

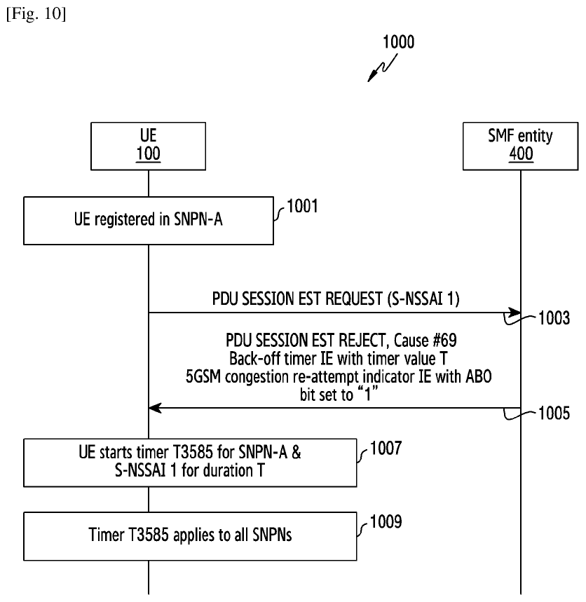

FIG. 10 illustrates an example scenario in which mobility registration update in SNPN is depicted, according to embodiments as disclosed herein.

As shown in FIG. 10, consider that, at step 1001, the UE (100) is registered in SNPN-A. At step 1003, the UE (100) triggers PDU session establishment request for S-NSSAI 1. At step 1005, the UE (100) gets rejected with cause #69, and a non-zero back-off timer value. The ABO bit in the 5GSM congestion re-attempt indicator IE is set to value.
1. The back-off timer will be applicable not only to the registered SNPN, but to all SNPNs or only belonging to at least one of the below SNPNs optionally of selected entry of the “list of subscriber data” or the PLMN subscription:
a. a user controlled prioritized list of preferred SNPNs, where each entry contains an SNPN identity;
b. a credentials holder controlled prioritized list of preferred SNPNs, where each entry contains an SNPN identity; and
c. a credentials holder controlled prioritized list of Group IDs for Network Selection (GINs).

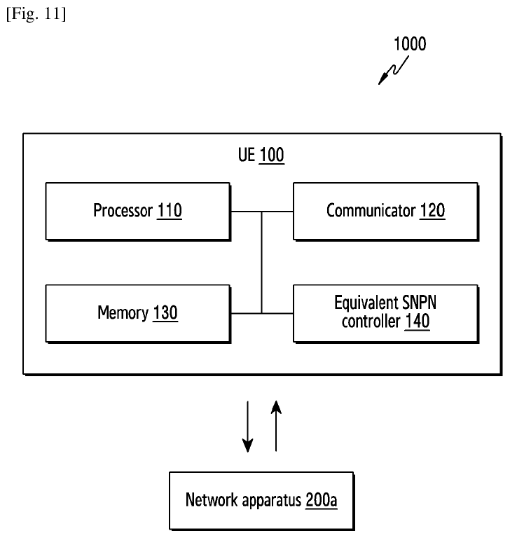

At step 1007, the UE (100) starts timer T3585 for SNPN-A & S-NSSAI 1 for duration T. At step 1009, the timer T3585 applies to all SNPNs FIG. 11 illustrates various hardware components of the UE (100), according to the embodiments as disclosed herein. The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IOT) device. In an embodiment, the UE (100) includes a processor (110), a communicator (120), a memory (130) and an equivalent SNPN controller (140). The processor (110) is coupled with the communicator (120), the memory (130) and the equivalent SNPN controller (140).

The equivalent SNPN controller (140) sends the registration request message to a network apparatus (200a) (e.g., AMF entity (200) or the like). The registration request message includes information of the first SNPN as the hosting network for the UE (100). In an embodiment, the equivalent SNPN controller (140) configures with the first SNPN in credentials holder prioritized list of preferred SNPN for access for the localized services in the SNPN. The first SNPN configured in the SNPN is broadcasting a GIN configured in the credential's holder prioritized list of preferred SNPN to access for the localized services in the SNPN. Further, the equivalent SNPN controller (140) enables to access the localized services. Further, the equivalent SNPN controller (140) triggers automatic network section of the hosting network. Further, the equivalent SNPN controller (140) sends the registration request message to the network apparatus (200a).

Further, the equivalent SNPN controller (140) receives the registration accept message from the network apparatus (200a). The registration accept message includes information of second SNPN as the hosting network for the UE (100). The second SNPN is an equivalent SNPN for the first SNPN. Further, the equivalent SNPN controller (140) determines validity conditions for the second SNPN. The validity conditions for the second SNPN is same as validation conditions of the first SNPN. The validity conditions include validity information about a validity time of the second SNPN registered as the hosting network, or the GIN broadcasted by the first SNPN.

Further, the equivalent SNPN controller (140) selects or reselects the second SNPN to access localized services based on the validity conditions for the second SNPN.

In an embodiment, when the UE (100) supports access to the SNPN using credentials from the credential holder, the equivalent SNPN controller (140) continues selecting and attempting registration on available and allowable SNPNs which broadcasts the indication that access using credentials from the credential holder, and indicates with the validity information with the UE (100) from the SNPN. In an embodiment, the equivalent SNPN provides access to the localized services as the UE (100) was last registered with the SNPN.

In an embodiment, the equivalent SNPN controller (140) detects that the UE (100) supports access to the second SNPN as equivalent SNPN for the first SNPN. Further, the equivalent SNPN controller (140) camps the first SNPN to the second SNPN when the UE (100) supports access to the second SNPN as equivalent SNPN for the first SNPN. Further, the equivalent SNPN controller (140) performs the mobility registration update while moving from the first SNPN to the second SNPN.

In an embodiment, the equivalent SNPN controller (140) skips triggering of an initial registration procedure by the UE (100) while moving the first SNPN to the second SNPN.

In an embodiment, the equivalent SNPN controller (140) receives the reject message comparing a re-attempt indicator from the network apparatus (200a) for the first SNPN. The re-attempt indicator includes the back-off timer value. Further, the equivalent SNPN controller (140) applies the back-off timer value to the second SNPN which is equivalent for the first SNPN.

In an embodiment, the equivalent SNPN controller (140) receives the reject message including the re-attempt indicator from the network apparatus (200a) for the first SNPN. The re-attempt indicator includes the ABO bit (All PLMNs Back-off timer) indicating whether the back-off timer value is applicable in only for the first SNPN. The reject message is received or to the SNPN which is equivalent to the first SNPN. In an embodiment, the equivalent SNPN controller (140) applies the back-off timer value to the first SNPN, when the ABO bit indicates that the back-off timer value is applicable in only for the first SNPN. In another embodiment, the equivalent SNPN controller (140) applies the back-off timer value to the second SNPN which is equivalent for the first SNPN, when the ABO bit indicates that the back-off timer value is applicable in the second SNPN.

The equivalent SNPN controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (120).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal.

However, the term “non-transitory” should not be interpreted that the memory (130) is non-movable. In certain examples, a non-transitory storage medium may store data that can, over time, change (e.g., in Random Access Memory (RAM) or cache).

In an embodiment, the communicator (120) includes an electronic circuit specific to a standard that enables wired or wireless communication. The communicator (120) is configured to communicate internally between internal hardware components of the UE (100) and with external devices via one or more networks.

Although the FIG. 11 illustrates various hardware components of the UE (100) but it is to be understood that other embodiments are not limited thereon. In other embodiments, the UE (100) may include less or more number of components. Further, the labels or names of the components are used only for illustrative purpose and does not limit the scope of the invention. One or more components can be combined together to perform same or substantially similar function in the UE (100).

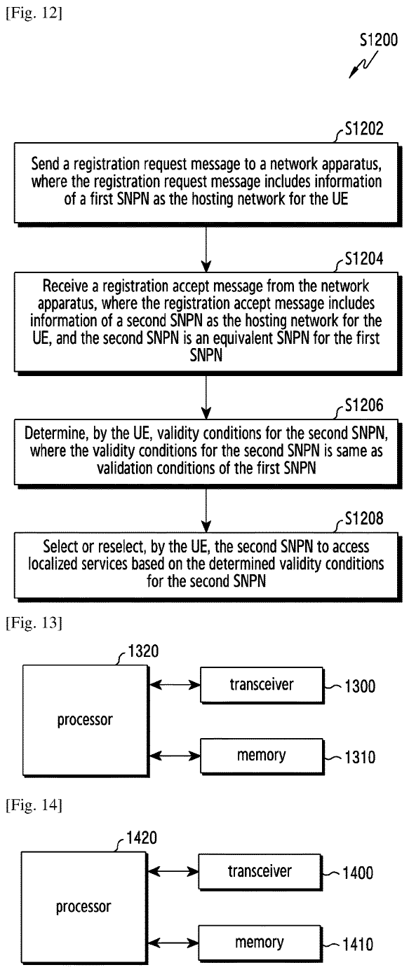

FIG. 12 is a flow chart (S1200) illustrating a method for managing behaviour of Equivalent SNPN as the hosting network in the telecommunication network (1000), according to the embodiments as disclosed herein. The operations (S602-S614) are handled by the equivalent SNPN controller (140).

At S1202, the method includes sending the registration request message to the network apparatus (200a). The registration request message includes information of the first SNPN as the hosting network for the UE (100).

At S1204, the method includes receiving the registration accept message from the network apparatus (200a). The registration accept message includes information of second SNPN as the hosting network for the UE (100). The second SNPN is the equivalent SNPN for the first SNPN.

At S1206, the method includes determining the validity conditions for the second SNPN. The validity conditions for the second SNPN is same as validation conditions of the first SNPN.

At S1208, the method includes selecting or reselecting the second SNPN to access localized services based on the validity conditions for the second SNPN.

The various actions, acts, blocks, steps, or the like in the flow chart (S1200) may be performed in the order presented, in a different order or simultaneously. Further, in some embodiments, some of the actions, acts, blocks, steps, or the like may be omitted, added, modified, skipped, or the like without departing from the scope of the invention.

FIG. 13 illustrates a block diagram of a terminal (or a user equipment (UE)), according to embodiments of the present disclosure. FIG. 13 corresponds to the example of the UE of FIG. 11.

As shown in FIG. 13, the UE according to an embodiment may include a transceiver 1310, a memory 1320, and a processor 1330. The transceiver 1310, the memory 1320, and the processor 1330 of the UE may operate according to a communication method of the UE described above. However, the components of the UE are not limited thereto. For example, the UE may include more or fewer components than those described above. In addition, the processor 1330, the transceiver 1310, and the memory 1320 may be implemented as a single chip. Also, the processor 1330 may include at least one processor.

The transceiver 1310 collectively refers to a UE receiver and a UE transmitter, and may transmit/receive a signal to/from a base station or a network entity. The signal transmitted or received to or from the base station or a network entity may include control information and data. The transceiver 1310 may include a RF transmitter for up-converting and amplifying a frequency of a transmitted signal, and a RF receiver for amplifying low-noise and down-converting a frequency of a received signal. However, this is only an example of the transceiver 1310 and components of the transceiver 1310 are not limited to the RF transmitter and the RF receiver.

Also, the transceiver 1310 may receive and output, to the processor 1330, a signal through a wireless channel, and transmit a signal output from the processor 1330 through the wireless channel.

The memory 1320 may store a program and data required for operations of the UE. Also, the memory 1320 may store control information or data included in a signal obtained by the UE. The memory 1320 may be a storage medium, such as read-only memory (ROM), random access memory (RAM), a hard disk, a CD-ROM, and a DVD, or a combination of storage media.

The processor 1330 may control a series of processes such that the UE operates as described above. For example, the transceiver 1310 may receive a data signal including a control signal transmitted by the base station or the network entity, and the processor 1330 may determine a result of receiving the control signal and the data signal transmitted by the base station or the network entity.

FIG. 14 illustrates a structure of a network entity according to an embodiment of the present disclosure.

As shown in FIG. 14, the network entity of the present disclosure may include a transceiver 1410, a memory 1420, and a processor 1430. The transceiver 1410, the memory 1420, and the processor 1430 of the network entity may operate according to a communication method of the network entity described above. However, the components of the terminal are not limited thereto. For example, the network entity may include more or fewer components than those described above. In addition, the processor 1430, the transceiver 1410, and the memory 1420 may be implemented as a single chip. Also, the processor 1430 may include at least one processor.

The transceiver 1410 collectively refers to a network entity receiver and a network entity transmitter, and may transmit/receive a signal to/from a base station or a UE. The signal transmitted or received to or from the base station or the UE may include control information and data. In this regard, the transceiver 1410 may include a RF transmitter for up-converting and amplifying a frequency of a transmitted signal, and a RF receiver for amplifying low-noise and down-converting a frequency of a received signal. However, this is only an example of the transceiver 1410 and components of the transceiver 1410 are not limited to the RF transmitter and the RF receiver.

Also, the transceiver 1410 may receive and output, to the processor 1430, a signal through a wireless channel, and transmit a signal output from the processor 1430 through the wireless channel.

The memory 1420 may store a program and data required for operations of the network entity. Also, the memory 1420 may store control information or data included in a signal obtained by the network entity. The memory 1420 may be a storage medium, such as ROM, RAM, a hard disk, a CD-ROM, and a DVD, or a combination of storage media.

The processor 1430 may control a series of processes such that the network entity operates as described above. For example, the transceiver 1410 may receive a data signal including a control signal, and the processor 1430 may determine a result of receiving the data signal.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-15. (canceled)

16. A method performed by a user equipment (UE) in a wireless communication system, the method comprising:
transmitting, to an access and mobility management function (AMF) entity of a first stand-alone non public network (SNPN), a registration request message;
receiving, from the AMF entity of the first SNPN, a registration accept message including information for a list of equivalent SNPNs;
selecting a second SNPN; and
initiating a mobility registration update from the first SNPN to the second SNPN, in case that the first SNPN and the second SNPN are included in the list of equivalent SNPNs.

17. The method of claim 16, wherein the mobility registration update is initiated in case that the second SNPN is accessible using credentials from a credential holder.

18. The method of claim 16, wherein, in case that a 5G session management (5GSM) reject message for the first SNPN is received from the AMF entity, the 5GSM reject message includes a re-attempt indicator, and
wherein the re-attempt indicator indicates that a command to back-off is applicable for the first SNPN and for at least one SNPN included in the list of equivalent SNPNs.

19. The method of claim 18, wherein, in case that a 5GSM message includes a cause value indicating insufficient resources for a specific slice and a data network name (DNN), or insufficient resources for the specific slice, and in case that the 5GSM message includes a 5GSM congestion re-attempt indicator including an all-equivalent SNPN back-off timer (ABO) bit, a back-off timer is applied for all SNPNs included in the list of equivalent SNPNs, and wherein, in case that the re-attempt indicator does not include the ABO bit, the back-off timer is applied for the first SNPN.

20. The method of claim 19, wherein the back-off timer includes timer T3584 or timer T3585.

21. A method performed by an access and mobility management function (AMF) entity in a wireless communication system, the method comprising:
receiving, from a user equipment (UE), a registration request message for a first stand-alone non public network (SNPN); and
transmitting, to the UE, a registration accept message including information for a list of equivalent SNPNs,
wherein, in case that the first SNPN and a second SNPN are included in the list of equivalent SNPNs, a mobility registration update is initiated from the first SNPN to the second SNPN.

22. The method of claim 21, wherein, in case that the second SNPN is accessible using credentials from a credential holder, the mobility registration update is initiated.

23. The method of claim 21, wherein, in case that a 5G session management (5GSM) reject message for the first SNPN is transmitted to the UE, the 5GSM reject message includes a re-attempt indicator, and wherein the re-attempt indicator indicates that a command to back-off is applicable for the first SNPN and for at least one SNPN included in the list of equivalent SNPNs.

24. The method of claim 23, wherein, in case that a 5GSM message includes a cause value indicating insufficient resources for a specific slice and a data network name (DNN), or insufficient resources for the specific slice, and in case that the 5GSM message includes a 5GSM congestion re-attempt indicator including an all-equivalent SNPN back-off timer (ABO) bit, a back-off timer is applied for all SNPNs included in the list of equivalent SNPNs, and wherein, in case that the re-attempt indicator does not include the ABO bit, the back-off timer is applied for the first SNPN.

25. The method of claim 24, wherein the back-off timer includes timer T3584 or timer T3585.

26. A user equipment (UE) in a wireless communication system, the UE comprising:
at least one transceiver;
at least one processor communicatively coupled to the at least one transceiver; and
at least one memory, communicatively coupled to the at least one processor, storing instructions executable by the at least one processor individually or in any combination to cause the UE to:
transmit, to an access and mobility management function (AMF) entity of a first stand-alone non public network (SNPN), a registration request message,
receive, from the AMF entity of the first SNPN, a registration accept message including information for a list of equivalent SNPNs,
select a second SNPN, and
initiate a mobility registration update from the first SNPN to the second SNPN, in case that the first SNPN and the second SNPN are included in the list of equivalent SNPNs.

27. The UE of claim 26, wherein the mobility registration update is initiated in case that the second SNPN is accessible using credentials from a credential holder.

28. The UE of claim 26, wherein, in case that a 5G session management (5GSM) reject message for the first SNPN is received from the AMF entity, the 5GSM reject message includes a re-attempt indicator, and
wherein the re-attempt indicator indicates that a command to back-off is applicable for the first SNPN and for at least one SNPN included in the list of equivalent SNPNs.

29. The UE of claim 28, wherein, in case that a 5GSM message includes a cause value indicating insufficient resources for a specific slice and a data network name (DNN), or insufficient resources for the specific slice, and in case that the 5GSM message includes a 5GSM congestion re-attempt indicator including an all-equivalent SNPN back-off timer (ABO) bit, a back-off timer is applied for all SNPNs included in the list of equivalent SNPNs, and
wherein, in case that the re-attempt indicator does not include the ABO bit, the back-off timer is applied for the first SNPN.

30. The UE of claim 29, wherein the back-off timer includes timer T3584 or timer T3585.

31. An access and mobility management function (AMF) entity in a wireless communication system, the AMF entity comprising:
at least one processor; and
at least one memory, communicatively coupled to the at least one processor, storing instructions executable by the at least one processor individually or in any combination to cause the network entity to:
receive, from a user equipment (UE), a registration request message for a first stand-alone non public network (SNPN), and
transmit, to the UE, a registration accept message including information for a list of equivalent SNPNs,
wherein, in case that the first SNPN and a second SNPN are included in the list of equivalent SNPNs, a mobility registration update is initiated from the first SNPN to the second SNPN.

32. The AMF entity of claim 31, wherein, in case that the second SNPN is accessible using credentials from a credential holder, the mobility registration update is initiated.

33. The AMF entity of claim 31, wherein, in case that a 5G session management (5GSM) reject message for the first SNPN is transmitted to the UE, the 5GSM reject message includes a re-attempt indicator, and
wherein the re-attempt indicator indicates that a command to back-off is applicable for the first SNPN and for at least one SNPN included in the list of equivalent SNPNs.

34. The AMF entity of claim 33, wherein, in case that a 5GSM message includes a cause value indicating insufficient resources for a specific slice and a data network name (DNN), or insufficient resources for the specific slice, and in case that the 5GSM message includes a 5GSM congestion re-attempt indicator including an all-equivalent SNPN back-off timer (ABO) bit, a back-off timer is applied for all SNPN included in the list of equivalent SNPNs, and
wherein, in case that the re-attempt indicator does not include the ABO bit, the back-off timer is applied for the first SNPN.

35. The AMF entity of claim 34, wherein the back-off timer includes timer T3584 or timer T3585.
